(19) United States
(12) Patent Application Publication
(10) Pub. No.: US 2010/0260302 A1
(43) Pub. Date: Oct. 14, 2010

(54) NUCLEAR REACTOR WITH IMPROVED COOLING IN AN ACCIDENT SITUATION

(75) Inventor: Roland Francis Pelisson, La Terrasse (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: Commissariat A L' Energie Atomique et Aux ENGN ALT, Paris (FR)

(21) Appl. No.: 12/738,918

(22) PCT Filed: Oct. 20, 2008
(86) PCT No.: PCT/EP08/64088

§ 371 Date: Apr. 20, 2010

(30) Foreign Application Priority Data
Oct. 22, 2007 (FR) 0758463

(51) Int. Cl. G21C 15/18

(52) U.S. Cl. 376/282

(57) ABSTRACT

A nuclear reactor including a vessel configured to hold a reactor core, a primary circuit cooling the reactor, a reactor pit in which the vessel is placed, an annular channel surrounding a lower portion of the vessel in the reactor pit, the channel configured to act as a thermal shield in normal operation and to ascend flow of a liquid in event of an accident, a reserve of liquid capable of filling the reactor pit, a reactor containment, a chamber collecting steam generated at an upper end of the reactor pit, the chamber being separate from the containment, a circulating pump capable of generating a forced convection of the liquid in the annular channel, and a lobe pump or steam piston machine or turbine for actuating the circulating pump and capable of generating forced convection by the collected steam.

### TECHNICAL FIELD AND PRIOR ART

The present invention relates to a nuclear reactor in which the cooling is improved in an accident situation, more specifically the exterior cooling of the vessel of the reactor in which is confined the reactor core, during a serious accident.

A nuclear reactor comprises, generally speaking, a reactor core containing nuclear fuel for example in the form of fuel rods or fuel plates, the core being confined in a vessel, a primary circuit enabling water to enter into the vessel, to circulate therein to withdraw the calories generated by the nuclear reaction in the core and exit the vessel. The reactor also comprises a secondary circuit, in which water also circulates. The primary and secondary circuits are isolated from each other, but heat exchanges take place between the water of the primary circuit coming out of the vessel and the water of the secondary circuit. The water of the secondary circuit is vaporised and sent to turbines to produce electric current.

In normal operation the reactor core is consequently flooded in water.

The vessel is, for its part, placed in a concrete pit serving as support thereof and forming a radiation shield.

Back up systems are provided to ensure the cooling of the core in the event of breakdown or leakage of the primary or secondary circuits causing a degradation to the normal cooling of the reactor. However, in the event of simultaneous failure of the back up systems, the residual power of the core is not evacuated in a sufficient manner, which causes a vaporisation of the water around the core causing a progressive reduction in the level of water in which the core is normally flooded.

The progressive vaporisation of the liquid water then causes the fuel rods (or fuel plates) of the core to heat up, said heating being amplified by the presence of steam which creates very exothermic oxidation reactions of the claddings of the fuel rods. The claddings break, freeing their contents and form a bed of debris capable of being transformed into magma, known as corium.

In these extreme cases, the reactor core tends to re-localise at the base of the vessel in the form of successive flows of corium. The bath thereby obtained (known as a corium bath), which represents several tens of tonnes at temperatures of the order of 2700 K, can cause a reduction in the thickness of the vessel, even its perforation.

One solution to avoid the perforation of the vessel is then to carry out an external cooling by flooding the vessel in water. To do this, the pit in which the vessel is placed is filled with the water available in the pools and other reserves of the nuclear power plant. Since heat exchanges with water are much better than those with air due to the low convection with air and the thermal radiation impeded by the presence of the shield, the external temperature of the vessel is maintained very close to that of the water. In such conditions, even at high fluxes, it is possible to maintain a sufficient wall thickness of the vessel and a temperature of the wall less than that of the creep temperature, which is of the order of 600° C., to ensure the confinement of the corium.

The cooling of the vessel then takes place through natural convection.

However, in practice, natural convection is often hindered by:
the insufficient space between the vessel and the thermal shield,
the licking of the lower wall of the vessel by the steam,
the appearance of vapour locks that form in the upper part the vessel.

In addition, the phenomenon of natural convection is accompanied by an important formation of steam bubbles on the external wall of the vessel, especially in cases where the energy fluxes between the water and the vessel are very high, of the order of the Megawatt/m² or more in the case of a large reactor.

These steam bubbles, when their quantity is limited, have a positive effect on the cooling of the walls of the vessel while causing a micro-mixing of the water along the wall, which favours the heat exchange phenomena; this phenomenon is known as nucleate boiling.

On the other hand, at very high thermal fluxes, the quantity of steam bubbles becomes very important and the steam bubbles are pinned against the wall, thereby forming a thermally insulating area, lowering the heat exchange coefficient between the wall and the water. This phenomenon is known as boiling crisis linked to the presence of a critical heat flux. In this case, for high power reactors, the wall is no longer cooled correctly, the integrity of the vessel may not be guaranteed. This boiling crisis, in the case of cooling by simple natural convection, can practically not be avoided.

It has for example been proposed, in order to delay the occurrence of the insulating layer of steam and thus the onset of the boiling crisis, to provide for the presence of nanoparticles in the water or a surface coating on the exterior face of the vessel, or even a simple oxidation thereof, intended to favour the wetting aspect of the wall and thus avoid the accumulation of steam bubbles.

Furthermore, for reactors of more than 600 MW, in particular in the case where a metal layer forms above the oxides of the corium bath, the thermal energy is focused in a zone of the vessel due to its horizontal convection and its high exchange coefficient with the wall of the vessel, this phenomenon is known as “focusing effect” leading to the perforation of the wall of the vessel at the spot where the energy of the corium bath is concentrated.

It is consequently an aim of the present invention to offer a safety system capable of avoiding the perforation of the vessel in the event of an accident without requiring external human intervention or input of external energy, the system being such that it can operate under extreme and variable conditions.

### DESCRIPTION OF THE INVENTION

The above mentioned aim is attained by a nuclear reactor provided with an autonomous system of placing in forced convection the cooling water situated around the vessel of the nuclear reactor, in the event of a serious accident, to enable the containment in the vessel of the corium, thanks to the risk of onset of departure from boiling crisis being pushed back beyond the maximum fluxes envisaged by serious accident scenarios.

The system comprises in particular a pump to force the flow of water along the exterior wall, said pump being driven by the steam from the water contained in the reactor pit, and in which the vessel is flooded in the event of an accident. Thus, no input of external energy is necessary to cause this forced convection. This forced convection is then ensured even in the event of serious breakdowns causing an interruption to the electricity supply.

In other words, it is provided to improve the external cooling under water of the vessel of the nuclear reactor by means bringing about a cooling by placing in forced convection the water around the vessel, said cooling being added to the cooling by natural convection, said means operating in an autonomous manner.

To do this, the reactor according to the present invention comprises means for recovering the steam generated around the vessel, means for actuating a pump from the kinetic energy of the steam—the kinetic energy of said steam not at present being profitably made use of—a pump driven by this energy, capable of causing a forced convection of the water around the vessel. A separating partition is formed in the reactor containment, so as to form a chamber for collecting the steam produced at the level of the reactor pit and causing the onset of an excess pressure. This partition separates the collecting chamber from the reactor containment.

The motive power of the excess pressure of steam collected is thus used.

In forced convection, the flow of water in circulation would be of the order of 3 m/s, whereas in natural convection the flow of water around the vessel may be estimated at around 0.5 m/s. Moreover, the critical heat flux, which leads to the perforation of the vessel, is a function of the mass flow to the power ⅓. Consequently, an increase in the mass flow of the water causes an increase in the critical heat flux, which is then pushed back beyond the maximal flux to which may be subjected the vessel in the “focusing effect” zone.

It should be noted that the present invention offers an ultimate safety system capable of operating under extremely degraded conditions, for example when all electrical or other power supplies, for example diesel, have failed.

The invention thus consists in placing in movement the water outside of the vessel along its wall by means of a pump favouring external convection, and does this by using the steam created through dissipation outside of the vessel of the residual energy from the melted core.

The invention has the advantage of being autonomous, effectively forming an ultimate safety system that does not require either the presence of an operator, or any source of energy other than that released by the accident.

Furthermore, the system according to the present invention privileges robustness, i.e. the ability to operate under extreme conditions, rather than high output operation, so that its operation is guaranteed under precarious conditions in which the circulating water may be charged with residues and steam leaks can exist following the accident.

Furthermore, the safety system according to the invention can operate over wide steam flow rate and pressure ranges, for example between 1 bar and 5 bars in the reactor containment and a steam flow rate that can attain up to 10 m³/s.

The subject-matter of the present invention is then mainly a nuclear reactor comprising a vessel intended to contain a reactor core, a primary circuit for cooling the reactor, a reactor pit in which is placed the vessel, an annular channel surrounding a lower portion of the vessel in the reactor pit, means capable of filling the reactor pit with a liquid, a reactor containment, means for collecting the steam generated at an upper end of the reactor pit separate from the reactor containment, means capable of generating a forced convection of the water in the annular channel, and means for actuating the means capable of generating a forced convection by means of said collected steam.

For example, the means capable of collecting the steam are formed by a collecting chamber separate from the reactor containment and comprise an evacuation passage placing in communication the collecting chamber and the reactor containment, the means for actuating the means capable of generating a forced convection being interposed in said evacuation passage to transform the kinetic/potential energy of the steam collected into motor energy driving the means capable of generating a forced convection.

The means for actuating the means capable of generating a forced convection advantageously comprise a lobe pump and a transmission mechanism connected to the means capable of generating a forced convection, the lobe pump offering considerable robustness and a high simplicity of construction.

The means capable of generating a forced convection may comprise a circulating pump placed in a lower end of the reactor pit at the level of an input of the annular channel.

The transmission mechanism comprises, for example, first and second shafts in gear respectively with the lobe pump and the circulating pump and an angle transmission between the first and second shafts. This mechanism is very simple and adapted to operating under extreme conditions.

The means for filling the reactor pit with liquid comprise for example a reserve of liquid and a duct connecting said reserve to the lower end of the pit, said duct being capable of supplying the pit with cooling air in normal operation.

The reserve capable of communicating with the collecting chamber and the duct is connected to the collecting chamber by a connector advantageously having a flared shape, which makes it possible to avoid cavitation phenomena.

The reserve is advantageously provided at a height above that of the reactor pit so that the flow of water from the reserve to the reactor pit takes place through gravity force which avoids the implementation of an additional device, or by means of a pump driven by the means for actuating the means capable of generating a forced convection; the cooling system is then completely autonomous.

The means for actuating the means capable of generating a forced convection may also be connected to a device for converting mechanical energy into electrical energy, to supply back up and/or monitoring systems.

The collecting chamber advantageously comprises a safety valve enabling an evacuation of the steam to the reactor containment in the event of the onset of an excess pressure in the collecting chamber greater than a given value, for example of the order of 0.3 bars.

The nuclear reactor may also comprise a water/steam separator upstream of the pump and the safety valve in cases of a collecting chamber of reduced dimensions.

Another object of the present invention is the use of the steam generated around a nuclear reactor when a reactor pit, in which is placed a vessel, is flooded in the event of an accident, to drive means capable of generating a forced convection around the vessel.

The steam generated may also be used to drive a pump for supplying the reactor pit with water.

The steam generated may also be used to produce electricity to supply monitoring devices.

### BRIEF DESCRIPTION OF DRAWINGS

The present invention will be better understood with the help of the following description and the appended drawings, among which:

FIG. 1 is a schematic sectional view partially representing a reactor provided with a safety system according to the present invention,

FIG. 2 is a graphic representation of the temperature distribution in the wall of the base of the vessel in the case of cooling under water of a reactor according to the present invention,

FIGS. 3A and 3B are graphic representations of the flow velocity of the water along the vessel in a reactor according to the invention and in a reactor of the prior art respectively,

FIGS. 4A and 4B are graphic representations of the pressure along the vessel in a reactor according to the invention and in a reactor of the prior art respectively.

### DETAILED DESCRIPTION OF SPECIFIC EMBODIMENTS

The present invention will be described within the scope of a pressurised water reactor (PWR) of high power, greater than 1000 MWe, but the present invention also applies to reactors of lower power.

In the description that follows, the cooling liquid used is pure water, but any other composition offering appropriate thermal properties may be suitable (dirty run off water, water charged with nanoparticles to favour exchanges, etc.).

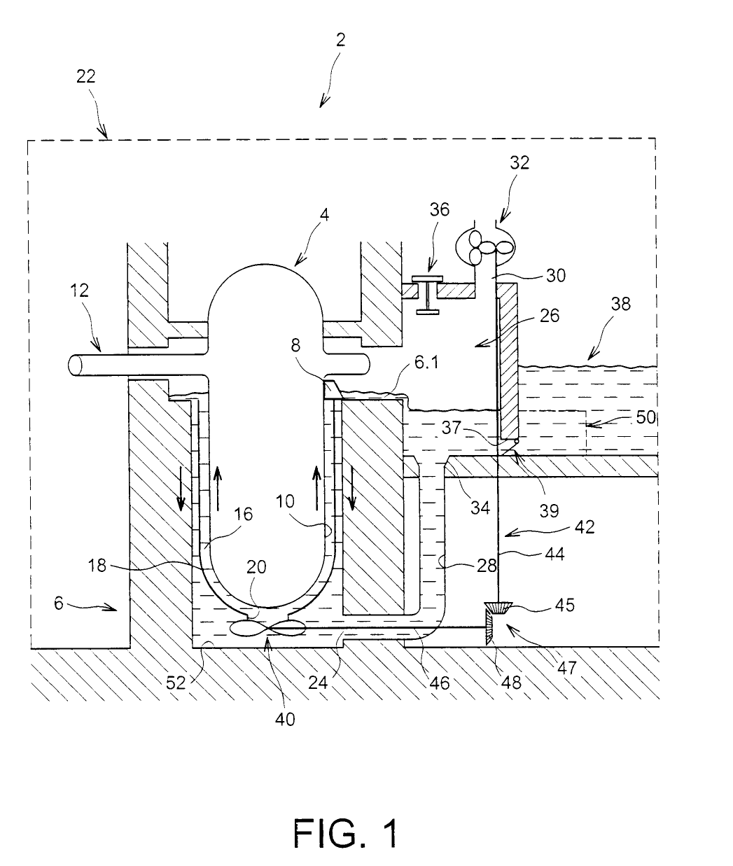

In FIG. 1, may be seen partially represented a reactor 2 according to the present invention comprising a vessel 4, a lower portion of which is placed in a concrete reactor pit 6. The vessel rests on an upper end 6.1 of the reactor pit 6 through the intermediary of an annular flange 8 projecting in a radial manner towards the exterior of the vessel. The vessel 4 is received with play in the reactor pit 6, an annular space is then present between the side wall 10 of the vessel and the wall of the reactor pit 6.

The vessel 4 delimits a confined space receiving the nuclear fuel forming the reactor core (not represented); the nuclear fuel is for example in the form of an assembly of nuclear fuel rods (or nuclear fuel plates).

The reactor pit 6 also comprises a shield against the thermal radiations emitted by the reactor core.

The reactor 2 also comprises a primary circuit 12 formed by hydraulic ducts going into and coming out of the vessel above the reactor pit 6, and through which the water enters and exits the vessel 4. This water forms a heat conveying medium intended to collect the energy of the reactor core. The primary circuit cooperates with a secondary circuit (not represented) by which the fluid that it conveys is cooled. The steam generated in the secondary circuit serves to run turbines intended to produce electricity.

An annular channel 16 is provided around the wall of the vessel 4 to ensure a role of thermal insulation in normal operation and natural convection of the water in degraded operation, when the reactor pit 6 is flooded.

This coolant channel 16 is delimited by a metal casing 18 surrounding the lower portion of the vessel 4 located in the reactor pit 6.

This casing 18, having the shape of the lower portion of the vessel 4 and acting as thermal shield in normal operation, comprises a passage 20 in its lower end for the input of water in accidental operation.

This casing 18 forms a thermal shield protecting the concrete from the thermal radiation and maintains it at a moderate temperature, a circulation of air being provided between the exterior of said shield and the concrete of the reactor pit 6.

The reactor also comprises a reactor containment 22 surrounding the vessel 4 intended to avoid, for example in the event of rupture of the primary circuit, a leak of water charged with radioactive elements. The reactor containment is a casing, generally of cylindrical shape, of large volume, made for example of concrete and which surrounds the reactor, the primary circuit, the exchangers and the primary pumps.

A thermal shield may also be provided at the level of the upper end of the casing 18 in order to protect the concrete structure at the level where it supports the vessel 4.

The supporting flange 8 and the upper thermal shield are provided to avoid forming obstacles to the evacuation of the cooling air and the water depending on the operation.

At the base of the reactor pit 6 is provided an inlet for the intake 24 of cooling air in normal operation, forming a supply of water to the reactor pit in order to flood it.

According to the present invention, the reactor provides to confine the steam produced during cooling under water in the event of an accident and to use the kinetic/potential energy of the steam to drive a pump capable of causing a forced convection in the annular cooling channel 16.

To do this, the reactor comprises means for collecting the steam produced during cooling under water of the vessel and for conveying it to an area in which it may be used to drive means enabling the water to be placed in movement.

These means seal in particular the passages of the ducts of the primary circuit made in the concrete structure, and comprise a chamber 26 added on one side of the reactor pit 6 in communication with it. The chamber 26 is situated in the containment, while at the same time being separated from the reactor containment so as to form a sealed volume in relation to the large volume of the reactor containment.

The collecting chamber 26 is more particularly in communication with the upper end of the coolant channel 16.

This partitioning inside the containment isolates a small volume of the reactor containment in relation to its total volume. This small volume receives the steam produced in the reactor pit and enables the onset of a local excess pressure which will be exploited as motive power.

This chamber 26 collects hot air in normal situation coming out and the steam plus a part of the water coming out of the coolant channel in accidental situation 16. It is, for example, made of reinforced concrete capable of withstanding a differential pressure with the reactor containment of 0.5 bars. It communicates in the lower part with a duct 28 opening out into the inlet for the intake 24 ensuring the supply of the reactor pit 6 with fresh air in normal operation and the supply of the reactor pit 6 with water in accidental situation as will be explained hereafter.

The collecting chamber 26 comprises in an upper portion an outlet 30 for the evacuation of steam, this outlet 30 being equipped with means 32 capable of driving a pump by means of the steam, said means 32 are, for example a turbine or a lobe pump.

In an advantageous manner, a lobe pump is chosen to recuperate the energy from the steam, because it is particularly robust. In fact, it only comprises two rotating moving parts and does not require maintenance. Bearings with higher properties than those required may furthermore be used in order to yet further increase the durability of the pump.

In addition, start-up is automatic, even in the case of a low steam flow rate, unlike a turbine. The pressure applied to the lobes is directly transmitted to the pump accelerating the circulation of the fluid around the vessel.

Using a steam piston driven machine could also be envisaged.

The collecting chamber 26 also comprises a gravity operated safety valve 36, guaranteeing that the upper limit of the excess pressure will never be attained, this limit being for example between 0.2 and 0.3 bars. This safety valve 36 is intended to operate, for example in the case where the lobe pump or the turbine was not working and would prevent the steam from escaping to the reactor containment.

The collecting chamber comprises in its lower portion an output 34 connected to the duct 28 opening out into the base of the reactor pit 6.

In the example represented, the collecting chamber 26 is capable of communicating with reserves of water 38, for example stored in pools to be able, in the event of a serious accident, to flood the reactor pit, the water coming from these reserves flowing via the duct 28 into the reactor pit 6.

The placing in communication of the collecting chamber 26 and reserves 38 may be achieved by a horizontal channel 37 situated at the lower level of the collecting chamber 26 and communicating with the reactor containment.

It may be envisaged that the filling of the reactor pit 6 takes place through gravity, the reserves of water being raised compared to the pit.

Furthermore, it is provided to regulate the level of liquid water in the pit in order to maintain it substantially constant despite evaporation.

Provision may then be made for:
a pump driven by steam via the lobe pump which injects the liquid into the pit to compensate the losses of fluid due to the steam that escapes, the maximum quantity of water injected should be around 10 kg/s. In this case, the horizontal channel 37 situated at the lower level of the chamber 26 for collecting the steam is provided with a non-return valve 39 to guarantee the excess pressure in the chamber 26 is maintained,
that the compensation of the volume of water evaporated is carried out by an input of water delivered by gravity from a permanent reserve of water situated at around 2 to 3 m above the requisite level of water in the vessel, which would ensure an input of water despite the higher internal pressure in the system, which is at the most 0.3 bars due to the taring of the safety valve. The compensation by gravity has the advantage of reducing the number of moving parts, which is preferable for an operation under degraded conditions.

Advantageously, provision is made to place filtering means 50 in the supply of water preventing too much debris from penetrating. Indeed, during an accident, part of this water will come from the condensation of steam in the containment (on the walls or via spray rings) and its run off up to the reactor pit. In the example represented, the filtering means are placed in the reserve of water.

A deposition area 52 may also be provided for in the base of the reactor pit, this deposition area is located below the intake inlet 24, this deposition area 52 completes advantageously the filtration carried out the means 50.

In the example represented, the reserve of water 38 is represented adjacent to the collecting chamber 26, but it is obvious that it may be provided at a distance from it and connected to it by ducts. It may be provided that there are several reserves separated geographically. For example, it may be provided that certain reserves are safety reserves activated at the start of an accident to flood the reactor pit 6 and that other reserves are reservoirs for collecting run off water during cooling of the vessel. In this case, several separate ducts for supplying the pit with water are provided for.

The lobe pump 32 is mechanically connected to a circulating pump 40 placed in the base of the reactor pit 6, just below the passage 20 in the base of the annular casing 18, to place in forced convection the cooling water.

The lobe pump 32 is connected to the circulating pump by a mechanical transmission 42 capable of transmitting the rotation of the lobe pump or the turbine 32 into rotation of the circulating pump 40. In the example represented, the mechanical transmission comprises a first shaft 44, a second arm 46 and an angle transmission 47 between the two shafts 44, 46, ensuring an appropriate gear reduction.

The first arm 44 is in mesh at a first end with the lobe pump or the turbine 32, and comprises at a second end a bevel pinion 45, and a second shaft 46 orthogonal to the first shaft 44 provided at a first end with a bevel pinion 48 gearing with the bevel pinion 45 and in gear with a second end with the circulating pump 40.

The transmission mechanism may obviously be of more complex shape and have an improved efficiency, but preference is given to a robust mechanism capable of operating under degraded conditions.

The circulating pump 40, due to its placement at the base of the vessel, is intended to operate at a temperature slightly below the saturation temperature, it is thus going to operate close to cavitation. Consequently, it is preferable to chose to position it as low as possible in the circuit and to choose it with large dimensions so that it creates a low inlet vacuum. A shrouded propeller as circulating pump may for example be chosen.

Advantageously, provision is made so that the linking of the duct 28 to the collecting chamber 26 is flared, which makes it possible to reduce to the maximum the local head losses linked to the connection of a pipe to a volume. In fact, at this spot, the cooling water is close to the saturation temperature, consequently a phenomenon of cavitation could appear at this spot if the flow is not optimised, which could partially fill the duct with steam. By choosing such a link, this risk of cavitation is reduced.

It may also be envisaged to couple the lobe pump 32 to an electric generator (not represented), in parallel with the circulating pump 40, to supply annexe systems, such as monitoring systems, for example such as state indicators, such as temperature or radioactivity sensors, and additional back up systems. This advantageously makes it possible to have a completely autonomous system.

The operation of the safety system according to the invention will now be explained, and more generally the behaviour of the reactor according to the invention will now be described.

In normal operation, the water circulates in the vessel 4 by means of the primary circuit, this water is heated by heat exchanges with the reactor core. The heated water is cooled by heat exchanges with the secondary circuit, the steam produced in the secondary circuit is used to actuate turbines and produce electricity. Thanks to the heat exchanges between the reactor core and the primary circuit and between the primary circuit and the secondary circuit, the temperature of the reactor core is maintained at a temperature at which the integrity of the fuel rods is ensured.

In the event of breakdown in the core cooling system, for example in the secondary circuit and in the event of a failure of the back up cooling systems, the boiling of the water of the primary circuit, despite the shut down of the core (drop of the control rods) leads to its dewatering, its temperature then attains a temperature causing the melting of the sheaths of the fuel rods, there is then formation of corium. Cooling by natural convection is not sufficient. An important risk of perforation of the wall of the vessel arises.

The safety system according to the invention provides for the filling of the reactor pit 6 with the water to flood the exterior of the vessel 4 by means of the water contained in the reserves, the water flows into the pit through the duct 28 or through other ducts directly linked to the safety reserves.

The water surrounding the vessel 4 evaporates partially; the steam thereby formed is collected in the collecting chamber 26, the chamber passes into slight excess pressure, then the steam flows via the evacuation outlet of the collecting chamber, causing the rotation of the lobe pump 32, which, via the transmission 42, drives the circulating pump 40 placed at the base of the reactor pit 6. The actuation of this pump 40 then produces a forced convection of the water, thereby avoiding the onset of departure from nucleate boiling; the perforation of the vessel is thereby avoided.

The return of the water is carried out in part by the channel delimited by the casing 18 and the wall of the reactor pit 6, and in part by the duct 28 via the collecting chamber 26. The volume of water evaporated is evacuated as described previously.

The invention has the advantage of not disrupting the conventional operation of the cooling system. In fact, in normal operation, the cooling air circumvents the pump 40, and in the event of an accident, if the pump does not work, the natural convection of the water takes place normally by circumventing the blades of the pump 40.

The simulation results obtained by means of the European software programme for computing nuclear power plant accident scenarios, ASTEC V1, this software having been adapted to deal with the case of containment in the vessel with external cooling, will now be described.

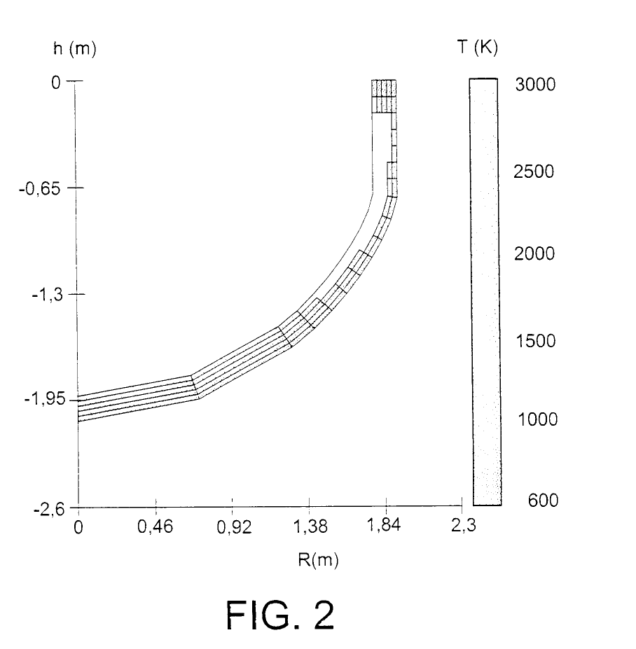

FIG. 2 represents the temperature T in K distribution in the base of the wall of the vessel, 3349 seconds after a corium bath is poured in a single flow into the vessel base. A lower quarter of the base of the vessel is represented, on the X-axis the radius R of the vessel in metres and on the Y-axis the height h in metres of the vessel are given.

For the simulation, it was considered that the water outside of the vessel circulated in forced convection in a coolant channel of 15 cm thickness. This geometry corresponds to that of a high power reactor.

It may be observed that, thanks to the invention, the temperature of the base of the vessel is maintained between 600 K and 1000 K, in other words below the creep temperature, thus avoiding the perforation of the vessel.

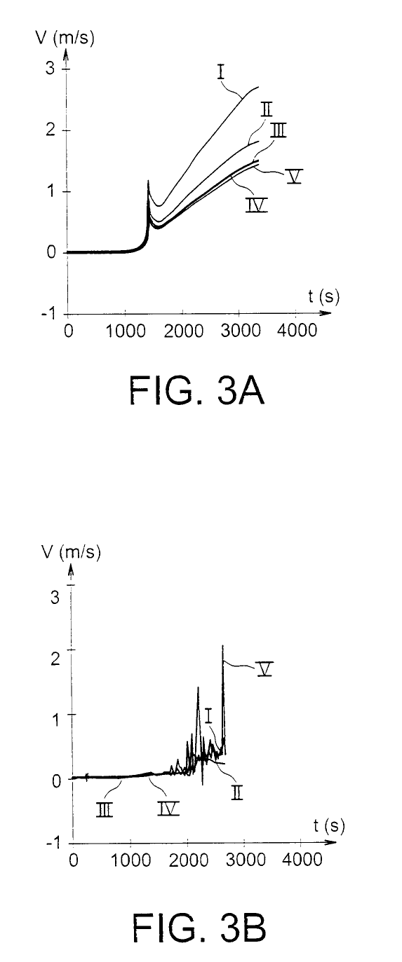

The curve of FIG. 3A represents the velocities V of the water in m/s circulating in the coolant channel in the reactor according to the invention at different heights consequently under forced convection as a function of the time t in s; FIG. 3B represents the velocity V of the water in m/s in natural convection in the coolant channel at different heights as a function of the time t in s. The references I, II, III, IV, and V used designate different heights from bottom to top.

It may be noted that, thanks to the invention, there is six-fold rise in the flow velocity of the water in the vessel base area where the corium is situated. The flow regime is not disrupted either by the steam forming on rising thanks to the excess pressure generated by the circulating pump 40. Thanks to the invention, a gain of 80% on the maximal admissible flux is obtained, i.e. the flux at which departure from nucleate boiling appears, since the value of the flux depends on the velocity to the power of one third.

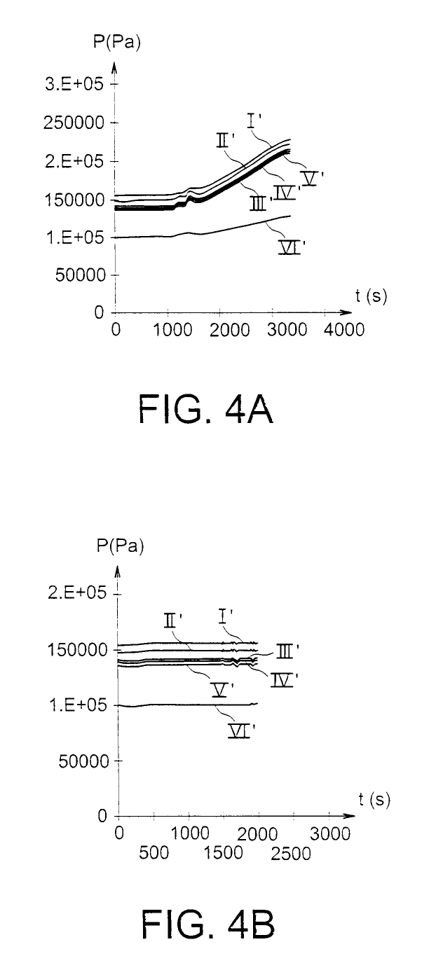

The curve of FIG. 4A represents the pressure P in Pa in the coolant channel 16 at different heights generated by the circulating pump in the system according to the present invention in the coolant channel 16 of the vessel 4 as a function of the time t in seconds. The appearance may be noted of an excess pressure making it possible, among other things, to avoid the formation of vapour locks on rising, which improves the natural convection and thus the cooling. The references I′, II′, III′, IV′, V′ and VI′ used designate different heights from bottom to top.

The following have been taken for the simulation:
a local head loss coefficient at the upper outlet of the annular space, at the spot where the cooling water moves away from the vessel, equal to 0.5, identical to that of a duct coming out at a sharp angle,
a local head loss coefficient, at the top of the descending channel supplying the pump is taken equal to 0.03, identical to that of a circular collector with relatively high bend radius.

FIG. 4B represents the pressure generated in the coolant channel of a reactor of the prior art at different heights. No excess pressure is observed. Consequently, the risks of appearance of vapour locks are greater than for the reactor according to the invention.

It should be noted that the collection of the steam is not necessarily of high quality, indeed it is possible to provide that the system for recovering the energy of the steam can be very rudimentary and with a low efficiency, since the energy emitted is very high, indeed the residual power released by the core is of the order of 20 MW initially, then subsequently decreases, by way of example, it is that of twenty steam locomotives or a ferryboat; and the energy necessary for the operation of the circulating pump 40 is low compared to the quantity of steam released. Likewise, the sealing at the level of the primary circuit may be crude without adversely affecting the power required by the system.

The performance of this system increase advantageously when the strongest fluxes take place, unlike systems working only in natural convection which attain their limits when the heat flux to be evacuated is high. Its total operating autonomy and its automatic start up thus enable the cooling system according to the invention to substitute for cooling by natural convection as soon as the quantity of steam produced is sufficient.

By way of example, the following dimensions may be given: for a vessel of 4 m diameter, an annular space 16 between 5 cm and 15 cm width would be suitable, this value having been obtained by the SULTAN experiment, conducted at the CEA in Grenoble, on the study of the departure from nucleate boiling in a heated sloping channel in forced convection). Furthermore, knowing moreover that the steam can attain 10 kg/s, i.e. more than 10 m³/s at operating pressure, a collecting chamber 26 of large volume is preferable, for example 10 m³ or more. This also facilitates maintenance operations. In the case of a more reduced geometry, provision may be made to add a water/steam separator device upstream of the lobe pump and the safety valve.

The present invention is particularly adapted to in-vessel retention reactors, in particular pressurised water reactors (PWR).

The present invention applies to reactors with cooling under water by convection, but may also apply to other types of reactors, particularly boiling water reactors for example. It also applies to any reactor (pressurised water type (PWR) or other) for which the geometry at design has not been provided for external cooling of the vessel under water in natural convection. In this case, due to the inappropriate or too narrow geometry, only a passage of water in forced convection obtained in a simple and robust manner by the present invention can assure the integrity of the vessel.

1-15. (canceled)

16. A nuclear reactor comprising:
a vessel configured to contain a reactor core;
a primary circuit configured to cool the reactor;
a reactor pit in which is placed the vessel;
an annular channel surrounding a lower portion of the vessel in the reactor pit;
a system configured to fill the reactor pit with a liquid;
a reactor containment in which are placed the reactor pit and the vessel;
a collector of steam generated at an upper end of the reactor pit, the collector being placed in the containment and defining a separate volume compared to a volume of the reactor containment so as to enable onset of an excess steam pressure;
a generator of a forced convection of the liquid in the annular channel; and
an actuator of the generator of a forced convection, by the collected steam.

17. A nuclear reactor according to claim 16, wherein the collector of the steam comprises a collecting chamber separate from the reactor containment, and an evacuation passage placing in communication the collecting chamber and the reactor containment, the actuator of the generator of a forced convection being interposed in the evacuation passage to transform kinetic/potential energy of the steam collected into driving power driving the generator of a forced convection.

18. A nuclear reactor according to claim 16, wherein the actuator of the generator of a forced convection comprises a lobe pump and a transmission mechanism connected to the generator of a forced convection.

19. A nuclear reactor according to claim 16, wherein the generator of a forced convection comprises a circulating pump placed in a lower end of the reactor pit at a level of an inlet of the annular channel.

20. A nuclear reactor according to claim 19, wherein the actuator of the generator of a forced convection comprises a lobe pump and a transmission mechanism connected to the generator of a forced convection, and the actuator of the generator of a forced convection comprises a lobe pump and a transmission mechanism connected to the generator of a forced convection, and the transmission mechanism comprises first and second shafts in mesh respectively with the lobe pump and the circulating pump and an angle transmission between the first and second shafts.

21. A nuclear reactor according to claim 16, wherein the system for filling the reactor pit with liquid comprises a reserve of liquid and a duct connecting the reserve to the lower end of the reactor pit, the duct being capable of supplying the reactor pit with cooling air in normal operation.

22. A nuclear reactor according to claim 21, wherein the reserve is capable of communicating with the collecting chamber and the duct is connected to the collecting chamber by a flared connector.

23. A nuclear reactor according to claim 21, wherein the reserve is provided at a height superior to that of the reactor pit so that the flow of the liquid from the reserve to the reactor pit takes place through gravity.

24. A nuclear reactor according to claim 21, further comprising a pump driven by the actuator of a forced convection, configured to convey the liquid from the reserve to the reactor pit.

25. A nuclear reactor according to claim 16, wherein the actuator of the generator of a forced convection is also connected to a device for converting mechanical energy into electrical energy.

26. A nuclear reactor according to claim 16, wherein the collector of the steam comprises a collecting chamber separate from the reactor containment, and an evacuation passage in communication the collecting chamber and the reactor containment, the actuator of the generator of a forced convection being interposed in the evacuation passage to transform kinetic/potential energy of the steam collected into driving power driving the generator of a forced convection, and the collecting chamber comprises a safety valve enabling an evacuation of the steam to the reactor containment in event of appearance of an excess pressure in the collecting chamber greater than a given value, or greater than an order of 0.3 bars.

27. A nuclear reactor according to claim 26, wherein the generator of a forced convection comprises a circulating pump placed in a lower end of the reactor pit at a level of an inlet of the annular channel, the reactor also comprising a liquid/steam separator upstream of the pump and the safety valve.

28. Use of kinetic/potential energy of steam generated around a nuclear reactor in a reactor pit, when the reactor pit, in which is placed a vessel, is flooded in event of an accident, to drive means capable of generating a forced convection around the vessel.

29. Use of the steam generated according to the claim 28 to drive a pump for supplying the reactor pit with liquid.

30. Use of the steam generated according to claim 28 to produce electricity for supplying monitoring devices.
